(19) United States
(12) Patent Application Publication
(10) Pub. No.: US 2007/0186566 A1
(43) Pub. Date: Aug. 16, 2007

(54) Cryogenic fluid pumping system

(76) Inventor: Laurent Allidieres, Uriage Les Bains (FR)

Correspondence Address: AIR LIQUIDE;Intellectual Property, 2700 POST OAK BOULEVARD, SUITE 1800, HOUSTON, TX, 77056, US

(21) Appl. No.: 10/590,875

(22) PCT Filed: Feb. 16, 2005
(86) PCT No.: PCT/FR05/50098

§ 371 Date: Aug. 28, 2006

(30) Foreign Application Priority Data
Mar. 1, 2004 (FR) 0450397

(51) Int. Cl. F17C 13/00

(52) U.S. Cl. 62/50.6

(57) ABSTRACT

The inventive cryogenic fluid pumping system comprises at least one cryogenic fluid tank (8a, 8b), a cryogenic pump (18) having an input friction loss (NPSH) and a suction line (23a, 23b) connecting said tank (8a, 8b) to said pump (18). According to the invention, the pumping system comprises pressure control means for maintaining pressure in the suction line (23a, 23b) in such a way that said pressure is equal to or higher than an increased cryogenic fluid saturation pressure and the input friction loss (NPSH) of the cryogenic pump (18). Said invention can be used for pumping low-dense cryogenic fluids.

The present invention relates to a cryogenic fluid pumping system.

The invention finds a particularly advantageous application in the field of pumping low density cryogenic fluids such as hydrogen and helium, and isotopes thereof.

To compress hydrogen, for example, it is generally preferable to carry out a compression by pumping liquid hydrogen rather than hydrogen gas, because it is easier to compress a volume of liquid than a volume of gas, thereby reducing the compression costs.

However, the generation of high pressure hydrogen is extremely costly in terms of compression energy. The evaporation losses of liquid hydrogen in a cryogenic pump may also be high if the pump is not used optimally. Reducing these losses is a crucial element for optimizing the costs of obtaining high pressure hydrogen.

One of the problems raised by cryogenic pumps in general, and liquid hydrogen pumps in particular, resides in the fact that cryogenic fluids have very low densities, 70 g/l at 1 bar for hydrogen, for example. This very low density has the result of causing a number of drawbacks:
it is impossible to supply the cryogenic pump with the requisite inlet pressure drop compensation (called NPSH for “Net Positive Suction Head”) by a simple physical installation of the cryogenic source tank as head on the pumping system. For example, a LH2 700 bar liquid hydrogen pump has a NPSH of about 250 mbar, corresponding to a liquid hydrogen height of 35 m. This explains why it is not possible to operate the pump with a source tank installed as head on the pump at a height of 35 m; the inline pressure drops would in fact compensate for the installation of the tank as head.
low pressure saturated liquid hydrogen is denser than high pressure saturated liquid hydrogen. For example, the saturated hydrogen density is, as we have seen, 70 g/l at 1 bar, but it is not more than 56 g/l at 7 bar. Since cryogenic pumps are positive displacement pumps, this means that in order to increase the quantities of cryogenic fluid pumped, it is advantageous to make the fluid as dense as possible, hence to use the pump suction at the lowest possible pressure.

Document EP-A-010464, in the name of the Applicant, describes means for monitoring the starting sequence of pumping relatively dense cryogenic fluid (liquid nitrogen).

Thus, one technical problem to be solved by the object of the present invention is to propose a cryogenic fluid pumping system, comprising a cryogenic fluid tank, a cryogenic pump having an inlet pressure drop and a suction line connecting said tank to said pump, which would serve to remedy the drawbacks associated with the low density of the cryogenic fluids in terms of compensating for the inlet pressure drop of the cryogenic pumps and the quantities of cryogenic fluid sucked in.

The solution to the technical problem raised consists, according to the present invention, in that said pumping system comprises pressure control means for maintaining the pressure in the suction line at most as high as the cryogenic fluid saturation pressure plus the inlet pressure drop of the cryogenic pump.

In this way, the cryogenic fluid is subcooled and a suction of the subcooled fluid is obtained. The inlet pressure drop compensation is thereby achieved, avoiding any cavitation, while the fluid is maintained at a sufficiently low pressure to maximize the fluid density and hence the quantity pumped, contrary to existing systems for which no control is performed on the suction pressure, the tank being pressurized once and for all and the pressure always being higher than the theoretical minimum to obtain an optimal density.

According to one embodiment of the pumping system according to the invention, said pressure control means comprise a pressurizing valve and a depressurizing valve for the cryogenic fluid tank.

More specifically, the invention provides that said control means comprise a pressure sensor and a temperature sensor for respectively determining the pressure and temperature of the cryogenic fluid in the suction line, connected to a control unit for controlling said pressurizing and depressurizing valves.

In this latter case, the invention provides that said control means comprise a computation unit for calculating, from the temperature measured by said temperature sensor, a minimum value of the pressure measured by said pressure sensor equal to the liquid saturation pressure at said temperature plus the inlet pressure drop of the pump.

A further technical problem that the invention proposes to solve concerns the possibility of carrying out continuous operation of the pumping system of the invention, the known systems not permitting such operation because the pump must be stopped whenever the tank is empty in order to fill it and pressurize it before restarting the pump.

According to the present invention, the solution to this technical problem consists in that said system comprises a plurality of cryogenic fluid tanks arranged in parallel, at least one tank being filled with cryogenic fluid during the drainage of another tank.

The description that follows with reference to the drawing appended hereto, and given as a nonlimiting example, shows clearly what the invention comprises and how it can be implemented.

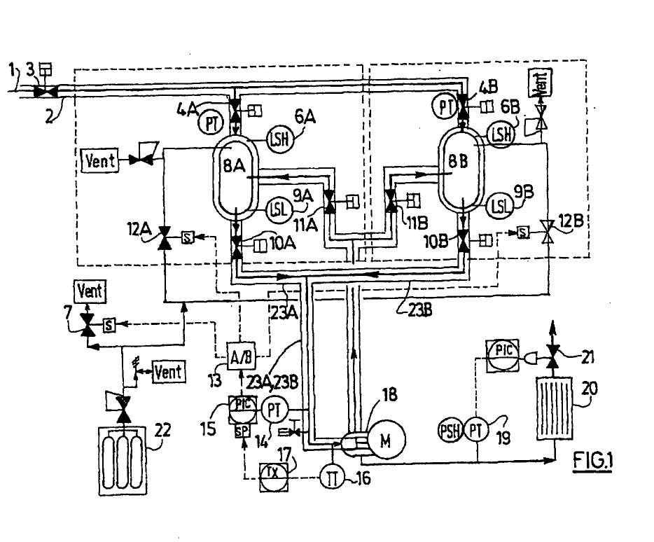

FIG. 1 is a diagram of a cryogenic fluid pumping system according to the invention.

FIG. 1 shows a cryogenic fluid pumping system, essentially comprising two cryogenic tanks 8a, 8b mounted in parallel on this liquid cryogenic fluid pump 18, each tank 8a, 8b being connected to said pump 18 by a respective suction line 23a, 23b.

Saturated liquid hydrogen with its vapor issuing from a source 1 is introduced into a line 2 isolated under vacuum from the pumping system via a source 1 disconnect valve 3. This liquid is used successively to fill the tanks 8a, 8b, in a continuous operating mode described in greater detail in the description.

In a first step, we shall assume that the cryogenic tank 8a is full. The tank 8a filling valve 4a is then closed, the tank 8a drain valve 10a and bypass return valve 11a are open, while the tank 8b drain valve 10b and bypass return valve 11b are closed. The cryogenic pump 18 is in operation, the delivery pressure 19 being controlled by a high pressure fluid control valve 21 located after a heat exchanger 20 for vaporizing high pressure fluid.

The pump suction pressure measured by a pressure sensor 14 is controlled by control means so that the temperature measured in the line 23a by a temperature sensor 16 is lower than the cryogenic liquid saturation temperature corresponding to this pressure. More specifically, the control means comprise a unit 17 for calculating the minimum value of the pressure 14 in the suction line 23a so that this pressure is equal to the liquid saturation pressure at the temperature 16 increased by the inlet pressure drop NPSH of the pump 18.

To maintain the pressure measured by the sensor 14 at the set point value determined by the computation unit 17, a control unit 15 opens or closes a tank 8a pressurizing valve 12a or depressurizing valve 7a, the selector 13 being in the “A” position because the tank 8a during pumping is at this time the tank 8a.

FIG. 1 shows that the pressurization of the tank 8a, like that of the tank 8b, is obtained by means of a pressurized gas source 22. Advantageously, the pressurizing gas of the pressurized gas source 22 is part of the fluid pressurized by the pump 18.

As a result, the pump 18 is effectively protected against cavitation and simultaneously, the pumped fluid is the densest possible, according to the goal of the invention.

Meanwhile, the second tank 8b is filled with saturated liquid fluid with its vapor.

When the tank 8a is empty, the low level detector 9a becomes active and the system closes the valve 4b then opens the drain valve 10b and bypass return valve 11b of the tank 8b. The valves 10a and 11a are closed and the tank 8a is filled via the filling valve 4a, while the pumping and pressure control sequence of the tank 8b begins.

A continuous production of pressurized cryogenic fluid is thereby obtained.

1-10. (canceled)

11. A cryogenic fluid pumping system, comprising at least one cryogenic fluid tank, a cryogenic pump having an inlet pressure drop (NPSH) and a suction line connecting said tank to said pump, wherein it comprises means for controlling the pressure in the suction line comprising control means for pressurizing and depressurizing the tank, for maintaining the pressure in the suction line at most as high as the cryogenic fluid saturation pressure plus the inlet pressure drop (NPSH) of the cryogenic pump.

12. The pumping system of claim 11, wherein said control means comprise a pressure sensor and a temperature sensor for respectively determining the pressure and temperature of the cryogenic fluid in the suction line, supplying signals to a control unit for controlling said pressurization means and depressurization means.

13. The pumping system of claim 12, wherein said pressurization and depressurization control means comprise a tank pressurizing valve and a tank depressurizing valve.

14. The pumping system of claim 12, wherein said control means comprise a computation unit for calculating, from the temperature measured by said temperature sensor, a minimum value of the pressure measured by said pressure sensor equal to the liquid saturation pressure at said temperature, plus the inlet pressure drop (NPSH) of the pump.

15. The pumping system of claim 11, wherein it comprises at least two cryogenic fluid tanks arranged in parallel, at least one tank being filled with cryogenic fluid during the drainage of another tank.

16. The pumping system of claim 11, wherein said tanks are filled with saturated cryogenic fluid with its vapor.

17. The pumping system of claim 11, wherein said cryogenic fluid is a low density fluid.

18. The pumping system of claim 17, wherein said low density cryogenic fluid is hydrogen or helium.

19. The pumping system of claim 11, wherein the tank is pressurized using a pressurized gas source.

20. The pumping system of claim 19, wherein the pressurizing gas of the pressurized gas source is part of the fluid pressurized by the pump.
